(19) United States
(12) Patent Application Publication
(10) Pub. No.: US 2023/0012550 A1
(43) Pub. Date: Jan. 19, 2023

(54) MINERAL OIL-FREE PRESSURE-SENSITIVE ADHESIVE

(71) Applicant: Henkel AG & Co., KGaA, Duesseldorf (DE)

(72) Inventors: Adrian Brandt, Essen (DE); Horst Beck, Neuss (DE); Alexander Kux, Monheim (DE); Benjamin Brammertz, Erkrath (DE)

(21) Appl. No.: 17/931,251

(22) Filed: Sep. 12, 2022

Related U.S. Application Data
(63) Continuation of application No. PCT/EP2021/055469, filed on Mar. 4, 2021.

(30) Foreign Application Priority Data
Mar. 13, 2020 (EP) 20162970.6

(51) Int. Cl. C09J 7/38; C08G 63/48; C08G 63/123

(52) U.S. Cl. CPC C09J 7/38; C08G 63/48; C08G 63/123; C09J 2203/334; C09J 2203/354; C09J 2301/302; C09J 2409/00; C09J 2425/00; C09J 2467/00; C08G 2170/00; C08G 2230/00

(57) ABSTRACT

The present invention relates to a pressure-sensitive adhesive composition containing at least one polymer and at least one polyester polyol based on betulin. The invention also relates to the use of the pressure-sensitive adhesive composition according to the invention, to a method for preparing the pressure-sensitive adhesive composition, and to a method for bonding at least two substrates. Finally, the invention relates to an article comprising the pressure-sensitive adhesive composition according to the invention.

The present invention relates to a pressure-sensitive adhesive composition containing at least one polymer and at least one polyester polyol based on betulin. The invention also relates to the use of the pressure-sensitive adhesive composition according to the invention, to a method for preparing the pressure-sensitive adhesive composition, and to a method for bonding at least two substrates. Finally, the invention relates to an article comprising the pressure-sensitive adhesive composition according to the invention.

For reasons of sustainability and growing environmental awareness, it is desirable to increasingly replace mineral-oil-based compounds with substances based on renewable raw materials.

Commercially available pressure-sensitive adhesive compositions typically contain plasticizers based on mineral oils. It is advantageous to reduce as much as possible or completely avoid the use of these substances, especially in food packaging, but also in hygiene articles, for example, and in many other fields, for example to prevent migration from the adhesive into the packaging material. Thus, there is need for substitutes that can partially or completely replace these plasticizers.

Many of the available alternatives based on renewable raw materials are disadvantageous in terms of compatibility with the other components of the pressure-sensitive adhesive composition and/or lead to a drop in performance with regard to the adhesive characteristics of the adhesive composition.

The object of the present invention is therefore to provide a pressure-sensitive adhesive composition which has the highest possible proportion of renewable raw materials in the formulation, in particular by largely replacing the previously used plasticizers based on mineral oils, which has, at the same time, the same or even improved performance compared to conventional systems in terms of adhesive strength and stability, and which is also suitable, for example, for the production of food packaging or hygiene articles.

It has surprisingly been found that this object is achieved by a pressure-sensitive adhesive composition which comprises at least one polymer and at least one polyester polyol based on betulin. This polyester polyol particularly preferably replaces the typically used plasticizers based on mineral oils, in particular naphthenic oils, in the pressure-sensitive adhesive composition at least partially, preferably even completely.

A first aspect of the invention therefore relates to a pressure-sensitive adhesive composition comprising

a) at least one polymer;
b) at least one polyester polyol based on betulin;
c) optionally at least one further plasticizer;
d) optionally at least one resin; and
e) optionally at least one additive, preferably at least one stabilizer.

The pressure-sensitive adhesive composition according to the invention preferably comprises at least one polymer selected from the group of polymers based on acrylate, polyester, urethane, ethylene acrylate, butyl rubber and (synthetic) (natural) rubber; ethylene-vinyl acetate copolymers (EVA), polyolefin (co)polymers (PO), polyamide (co)polymers (PA), ethylene-propylene copolymers or styrene copolymers, individually or as a mixture, said polymer particularly preferably being a styrene block copolymer such as a styrene and styrene-butadiene copolymer (SBS, SBR), a styrene-isoprene copolymer (SIS), a styrene-ethylene/butylene copolymer (SEBS), a styrene-ethylene/propylene-styrene copolymer (SEPS) or a styrene-isoprene-butylene copolymer (SIBS), most preferably a styrene-isoprene-styrene triblock copolymer. In general, synthetic rubbers are primarily used in various embodiments of the invention. It may be preferable for the at least one polymer to not be a NCO-terminated polymer and/or a polyurethane.

Particularly preferably, the polymer is contained in the composition in an amount of 10 to 70 wt. %, preferably 15 to 70 wt. %, more preferably 20 to 70 wt. %, for example 20 to 50 wt. % or 30 to 60 wt. %, based on the total weight of the composition.

In preferred embodiments, the polyester polyol is obtained from a reaction mixture comprising the following monomer units:

i) betulin, preferably in an amount of 5 to 40 wt. %, in particular 10 to 30 wt. %;
ii) at least one triglyceride, preferably in an amount of 30 to 95 wt. %, in particular 60 to 85 wt. %, for example 60 to 80 wt. %;
iii) optionally at least one dicarboxylic acid, preferably in an amount of 1 to 40 wt. %, in particular 1.5 to 40 wt. %, for example 2 to 40 wt. % or 5 to 20 wt. %;
wherein the weight specifications relate in each case to the total weight of the monomer units, and the total weight of components i)-iii) is preferably 100 wt. %.

In preferred embodiments, the polyester polyol is obtained from a reaction mixture comprising the following monomer units:

i) betulin, preferably in an amount of 5 to 40 wt. %, in particular 10 to 30 mol. %;
ii) at least one triglyceride, preferably in an amount of 30 to 95 mol. %, in particular 60 to 85 mol. %, for example 60 to 80 mol. %;
iii) optionally at least one dicarboxylic acid, preferably in an amount of 1 to 40 mol. %, in particular 1.5 to 40 mol. %, for example 2 to 40 mol. % or 5 to 20 mol. %;
wherein the amount specifications relate in each case to the total amount of the monomer units, and the total amount of monomer units i)-iii) is preferably 100 mol. %.

The triglyceride is preferably selected from the group consisting of soybean oil, linseed oil, sunflower oil, safflower oil, rapeseed oil, physic nut oil, light walnut oil, grapeseed oil, canola oil, corn oil, cashew kernel oil, fish oil, castor oil, tall oil, coconut oil, palm oil, palm kernel oil, olive oil, poppyseed oil, hempseed oil, avocado oil, algae oils, and mixtures or derivatives thereof. In various embodiments, rapeseed oil may be particularly preferred.

The dicarboxylic acid can be selected, for example, from the group consisting of aliphatic, cycloaliphatic and aromatic dicarboxylic acids having 2 to 20 carbon atoms, such as succinic acid, adipic acid, azelaic acid, sebacic acid, dodecanoic acid, tetradecanedioic acid, furandicarboxylic acid, isophthalic acid, terephthalic acid, orthophthalic acid, glutaric acid, oxalic acid, malonic acid, itaconic acid, anhydrides and mixtures thereof. In various embodiments, sebacic acid may be preferred.

In preferred embodiments, the polyester polyol is contained in the pressure-sensitive adhesive composition in an amount of 5 to 40 wt. % or 5 to 30 wt. %, for example 15 to 30 wt. % or 20 to 30 wt. %, based on the total weight of the composition.

The pressure-sensitive adhesive composition according to the invention can contain a further plasticizer, wherein the composition preferably comprises less than 5 wt. %, more preferably less than 3 wt. %, even more preferably less than 1 wt. %, even more preferably less than 0.5 wt. %, even more preferably less than 0.1 wt. %, even more preferably less than 0.01 wt. %, of further plasticizers, preferably of mineral oils, in particular of naphthenic oils, and is most preferably free of these further plasticizers, based on the total weight of the composition.

It is particularly preferable for the polyester polyol based on betulin to partially or completely replace the further plasticizer, in particular a plasticizer based on mineral oils.

In a preferred embodiment, the further plasticizer (or the required amount of plasticizer), more preferably the mineral oil, even more preferably the naphthenic oil, is replaced in the pressure sensitive adhesive composition by the polyester polyol based on betulin to a degree of at least 50%, more preferably at least 60%, even more preferably at least 70%, even more preferably at least 80%, even more preferably at least 90%, even more preferably at least 95%, even more preferably at least 98%, even more preferably at least 99%, and most preferably 100%.

Furthermore, the pressure-sensitive adhesive composition can comprise at least one resin, which is preferably a natural resin or a hydrocarbon resin, more preferably a tall oil ester, gum rosin (colophony), an optionally partially polymerized tall resin, a terpene or a crude-oil-based aliphatic, aromatic or cycloaliphatic hydrocarbon resin, and modified or hydrogenated versions thereof, for example C5 aliphatic or C9 aromatic hydrocarbon resin or a C5/C9 monomer mixture.

In particularly preferred embodiments, the resin is contained in the composition in an amount of 15 to 70 wt. %, for example 40 to 60 wt. %, 50 to 70 wt. % or 50 to 60 wt. %, based on the total weight of the composition.

In preferred embodiments, the pressure-sensitive adhesive composition according to the invention contains at least one additive, which is preferably selected from the group consisting of antioxidants such as stabilizers, waxes, UV protectors, solvents, adhesion promoters, fillers, pigments, flame retardants, UV absorbers, optical brighteners and fragrances, in particular stabilizers.

In various embodiments, the pressure-sensitive adhesive composition contains the at least one additive in an amount of 0.01 to 20 wt. %, preferably 0.1 to 5 wt. %, more preferably 0.5 to 3 wt. %, based on the total weight of the composition.

In a further aspect, the invention relates to a method for preparing the pressure-sensitive adhesive composition according to the invention, comprising the steps of:

a1) providing a reaction mixture comprising betulin, at least one triglyceride and optionally at least one dicarboxylic acid, from which the polyester polyol based on betulin is formed or has already formed partially or completely; or
a2) providing a polyester polyol based on betulin; and
b) mixing the reaction mixture from step a1) or the polyester polyol based on betulin from step a2) with other components of the pressure-sensitive adhesive composition, such as the polymer and optionally other components such as at least one further plasticizer, at least one resin and/or at least one additive, in a suitable sequence;
preferably at a temperature of 100 to 200° C., more preferably at 120 to 180° C.

In a further aspect, the invention relates to the use of the pressure-sensitive adhesive composition according to the invention in

adhesive tapes,
labels,
multi-layer films, e.g., for seals,
hygiene articles, e.g., diapers,
labeling, e.g., of beverage bottles,
flexible packaging,
food packaging,
in medical applications,
in the field of assembly (high performance, such as in the automotive industry), and/or
in the graphics industry (e.g., books, magazines, brochures).

Further examples include the coating of self-adhesive films. In general, the compositions described herein are suitable for film applications, i.e., self-adhesive films, tapes or labels.

In a further aspect, the invention relates to an article comprising the pressure-sensitive adhesive composition according to the invention.

The invention finally relates to a method for bonding at least two substrates, wherein the pressure-sensitive composition according to the invention is applied to at least one substrate and the at least two substrates are subsequently joined together.

These and other embodiments, features and advantages of the invention will become apparent to a person skilled in the art through studying the following detailed description and claims. Individual described features or embodiments of the invention can be combined with other features or embodiments of the invention without these having been described in combination within the scope of the invention. It is readily understood that the examples contained herein are intended to describe and illustrate, but not to limit, the invention and that, in particular, the invention is not limited to the examples.

“At least one,” as used herein, refers to 1 or more, for example 2, 3, 4, 5, 6, 7, 8, 9 or more. In connection with the polymers described herein, this does not refer to the absolute amount of molecules, but to the type of compound. “At least one polymer” therefore means, for example, that only one type of polymer or several different types of polymer can be contained without specifying the amount of the individual compounds.

Unless otherwise indicated, all amounts indicated in connection with the pressure-sensitive adhesive composition described herein refer to wt. %, in each case based on the total weight of the composition. Moreover, amounts that relate to at least one constituent always relate to the total amount of this type of constituent contained in the composition, unless explicitly indicated otherwise. This means that these amounts, for example in the context of “at least one polymer,” relate to the total amount of polymer contained in the composition, unless explicitly indicated otherwise.

Numbers stated herein with no decimal places refer to the full specified value with one decimal place. For example, “99%” stands for “99.0%.”

Numerical ranges that are specified in the format “in/from x to y” include the stated values. If several preferred numerical ranges are indicated in this format, it is readily understood that all ranges that result from the combination of the various endpoints are also included.

“Approximately,” as used herein in numerical terms, means the corresponding value ±10%, preferably ±5%.

When reference is made herein to molar masses, this always refers to the number-average molar mass Mn, unless explicitly indicated otherwise. The number-average molar mass can, for example, be determined by gel permeation chromatography (GPC) according to DIN 55672-1:2007-08 with THF as the eluent. The weight-average molar mass Mw can also be determined by means of GPC, as described for Mn.

The polyesters of the invention also include transesterification products of betulin with triglycerides, particularly the resulting macromers. The term “polyester,” as used herein, thus covers not only conventional polyesters with repeating units derived from acids and alcohols, but also the macromers described above, which are formed by transesterification of triglycerides with betulin.

Betulin is also known as 3a-hydroxymethyl-1-isopropenyl-5a,5b,8,8, 11a-pentamethyl-icosahydro-cyclopenta[a]chrysen-9-ol.

In a first aspect, the invention relates to a pressure-sensitive adhesive composition comprising

a) at least one polymer;
b) at least one polyester polyol based on betulin;
c) optionally at least one further plasticizer;
d) optionally at least one resin; and
e) optionally at least one additive, preferably at least one stabilizer.

The pressure-sensitive adhesive composition is preferably a hot-melt pressure-sensitive adhesive composition (HMPSA). More preferably, the pressure-sensitive adhesive composition is a non-reactive pressure-sensitive adhesive composition, in particular a non-reactive hot-melt pressure-sensitive adhesive composition.

A “pressure-sensitive adhesive” is a typical representative of a non-curing adhesive. “Hot-melt pressure-sensitive adhesives” (HMPSA) are generally understood to be adhesives that are solid at room temperature and are, in particular, water- and solvent-free. They are typically applied to the parts to be bonded from the melt and, after joining, set physically while cooling and solidifying. Such hot-melt pressure-sensitive adhesives preferably remain permanently tacky and adhesive when cooled and immediately adhere to almost all substrates under slight contact pressure.

“Non-reactive” or “physically setting” in this context typically means that the solidification takes place in a physical process (e.g., by hardening on cooling, or by evaporation of solvents or water).

The pressure-sensitive adhesive composition according to the invention contains at least one polymer.

Examples of such polymers include, but are not limited to, polymers based on acrylate, polyester, urethane, ethylene acrylate, butyl rubber and (synthetic) natural rubber; ethylene-vinyl acetate copolymers (EVA), polyolefin (co)polymers (PO), polyamide (co)polymer (PA), ethylene-propylene copolymers or styrene copolymers, individually or as a mixture, the copolymers typically being random, alternating graft or block copolymers. Thermoplastic elastomers are preferably selected from the group of styrene block copolymers, for example styrene and styrene-butadiene copolymers (SBS, SBR), styrene-isoprene copolymers (SIS), styrene-ethylene/butylene copolymers (SEBS), styrene-ethylene/propylene-styrene copolymers (SEPS) or styrene-isoprene-butylene copolymers (SIBS). Such products are known to a person skilled in the art and are commercially available.

Particularly preferably, the at least one polymer is a styrene block copolymer such as styrene-isoprene-styrene (SIS), styrene-butadiene-styrene (SBS), or styrene-ethylene-butadiene-styrene (SEBS), more preferably a styrene-isoprene-styrene triblock copolymer.

It may be preferable for the at least one polymer to not be a NCO-terminated polymer and/or a polyurethane.

In a preferred embodiment, the polymer is contained in the pressure-sensitive adhesive composition in an amount of 10 to 70 wt. %, preferably 15 to 70 wt. %, more preferably 20 to 70 wt. %, for example 20 to 50 wt. %, 30 to 60 wt. %, 25 to 50 wt. % or 28 to 40 wt. %, based on the total weight of the composition.

The polyester polyol contained in the pressure-sensitive adhesive composition according to the invention is preferably obtained by reacting betulin and one or more triglycerides. In a preferred embodiment, the triglyceride has at least one free hydroxyl group. In this case, the free hydroxyl group may already be present in the compound or be introduced by functionalization. In another preferred embodiment, the reaction of the betulin with the one or more triglycerides can be carried out in the presence of one or more dicarboxylic acids. The use of one or more dicarboxylic acids can preferably be used to adjust the viscosity and other properties of the polyester polyol.

The composition of the reaction mixture, from which the polyester polyol contained in the pressure-sensitive adhesive composition according to the invention is obtained, can be adjusted according to the properties of the polyester polyol that are to be achieved, for example its viscosity or its glass transition temperature. However, it has been found to be advantageous if the proportion of betulin in the reaction mixture is not too large, in order to prevent any problems when processing the raw materials.

In preferred embodiments, the polyester polyol has a glass transition temperature of −70° C. to 0° C., which can be determined by means of dynamic differential thermal analysis (DSC, differential scanning calorimetry).

In a preferred embodiment, the polyester polyol is obtained from a reaction mixture comprising the following monomer units:

i) betulin, preferably in an amount of 5 to 50 wt. %, more preferably 5 to 40 wt. %, even more preferably 10 to 35 wt. %, in particular 10 to 30 wt. % or 25 to 35 wt. %;
ii) at least one triglyceride, preferably in an amount of 20 to 95 wt. %, more preferably 30 to 95 wt. %, for example 20 to 85 wt. %, 20 to 80 wt. %, 30 to 80 wt. %, 40 to 80 wt. %, 60 to 80 wt. % or 40 to 70 wt. %; and
iii) optionally at least one dicarboxylic acid, preferably in an amount of 1 to 45 wt. %, more preferably 5 to 45 wt. % or 1 to 40 wt. %, even more preferably 1.5 to 40 wt. %, for example 2 to 40 wt. %, 5 to 20 wt. % or 8 to 40 wt. %;
wherein the weight specifications relate in each case to the total weight of the monomer units, and the total weight of monomer units i)-iii) is preferably 100 wt. %.

In a preferred embodiment, the polyester polyol is obtained from a reaction mixture comprising the following monomer units:

i) betulin, preferably in an amount of 5 to 50 mol. %, more preferably 5 to 40 mol. %, even more preferably 10 to 35 mol. %, in particular 10 to 30 mol. % or 25 to 35 mol. %;
ii) at least one triglyceride, preferably in an amount of 20 to 95 mol. %, more preferably 30 to 95 mol. %, for example 20 to 85 mol. %, 20 to 80 mol. %, 30 to 80 mol. %, 40 to 80 mol. %, 60 to 80 mol. % or 40 to 70 mol. %; and
iii) optionally at least one dicarboxylic acid, preferably in an amount of 1 to 45 mol. %, more preferably 5 to 45 mol. % or 1 to 40 mol. %, even more preferably 1.5 to 40 mol. %, for example 2 to 40 mol. %, 5 to 20 mol. % or 8 to 40 mol. %;
wherein the weight specifications relate in each case to the total weight of the monomer units, and the monomer units i)-iii) preferably amount in total to 100 mol. %.

The polyester polyol based on betulin is preferably liquid at room temperature.

In preferred embodiments, the at least one triglyceride is selected from, but not limited to, the group consisting of soybean oil, linseed oil, sunflower oil, safflower oil, rapeseed oil, physic nut oil, light walnut oil, grapeseed oil, canola oil, corn oil, cashew kernel oil, fish oil, castor oil, tall oil, coconut oil, palm oil, palm kernel oil, olive oil, poppyseed oil, hempseed oil, avocado oil, algae oils, and mixtures and derivatives thereof.

Castor oil, rapeseed oil, soybean oil and derivatives and mixtures of these compounds are particularly preferred, in particular castor oil, rapeseed oil and derivatives thereof. Furthermore, synthetic or biotechnologically prepared triglycerides can also be used.

The dicarboxylic acid is preferably a dicarboxylic acid selected from the group consisting of aliphatic dicarboxylic acids having 4 to 24 carbon atoms, aromatic dicarboxylic acids, dimer fatty acids and mixtures and derivatives thereof. The derivatives may be esters, acid chlorides or anhydrides of carboxylic acids, for example.

Suitable aliphatic dicarboxylic acids preferably include succinic acid, adipic acid, azelaic acid, sebacic acid, dodecanedioic acid, tetradecanedioic acid, and mixtures thereof.

Suitable aromatic dicarboxylic acids are preferably selected from the group consisting of phthalic acid, isophthalic acid, terephthalic acid, furandicarboxylic acid, anhydrides and methyl esters thereof, and mixtures thereof.

In a preferred embodiment, the dimer fatty acid or dimer fatty acids is/are dimers of fatty acids of the general formula CnH2n+1COOH, where n is an integer from 4 to 33, preferably 7 to 17. In preferred embodiments, in addition to dimer fatty acids, derivatives thereof are also used, which are obtained by hydrogenating or distilling the corresponding dimer fatty acids, for example. The fatty acid is also preferably selected from the group consisting of caprylic acid, capric acid, lauric acid, myristic acid, palmitic acid, stearic acid, the derivatives of these fatty acids and mixtures thereof.

In a particularly preferred embodiment, the dicarboxylic acid is selected from the group consisting of succinic acid, adipic acid, azelaic acid, sebacic acid, dodecanoic acid, tetradecanedioic acid, furandicarboxylic acid, isophthalic acid, terephthalic acid, orthophthalic acid, glutaric acid, oxalic acid, malonic acid, itaconic acid, and mixtures thereof, with succinic acid or sebacic acid in particular being used as the dicarboxylic acid.

The pressure-sensitive adhesive composition according to the invention contains the at least one polyester polyol based on betulin preferably in an amount of 1 to 50 wt. %, more preferably 2 to 40 wt. %, even more preferably 5 to 40 wt. %, even more preferably 5 to 30 wt. %, for example 10 to 30 wt. %, 15 to 30 wt. % or 20 to 30 wt. %, in each case based on the total weight of the pressure-sensitive adhesive composition.

Commercially available pressure-sensitive adhesive compositions usually contain plasticizers. These are used, for example, to reduce the viscosity of the pressure-sensitive adhesive composition and to improve wetting. Common plasticizers used in this context are, for example, medical white oils, naphthenic mineral oils, adipates, polypropylene, polybutylene and polyisoprene oligomers, hydrogenated polyisoprene and/or polybutadiene oligomers, benzoate esters, phthalates, plant or animal oils and the derivatives thereof, sulfonic acid esters, monohydric or polyhydric alcohols and polyalkylene glycols such as polypropylene glycol, polybutylene glycol or polymethylene glycol. Polybutylene oligomers should have a molecular weight of 200 to 6,000 g/mol, and polyolefins should have a molecular weight Mw of up to approximately 2,000 g/mol, in particular up to 1,000 g/mol. In particular, poly(iso)butylenes and liquid or pasty hydrogenated hydrocarbons are used, in particular polyisobutylene having a molecular weight Mw of less than 5,000.

Oily plasticizer components are often used. Examples of plasticizer components are liquid at room temperature, for example hydrocarbon oils, polybutylene/polyisoprene oligomers, (hydrogenated) naphthenic oils, paraffin oils or plant oils.

However, the pressure-sensitive adhesive composition according to the invention is preferably free of further plasticizers. It is particularly preferable for the polyester polyol based on betulin to partially or completely replace the conventional plasticizer, in particular based on mineral oils (e.g., naphthenic oil), in the pressure-sensitive adhesive composition according to the invention.

Mineral oils are typically produced by the distillation of crude petroleum and optionally other raw fossil materials. Mineral oils include, for example, paraffinic, naphthenic and aromatic hydrocarbons, alkenes and sulfur-containing and nitrogen-containing or organic compounds. The term “naphthenic oil” refers here in particular to saturated cyclic hydrocarbons.

In a preferred embodiment, the pressure-sensitive adhesive composition comprises less than 5 wt. %, more preferably less than 3 wt. %, even more preferably less than 1 wt. %, even more preferably less than 0.5 wt. %, even more preferably less than 0.1 wt. %, even more preferably less than 0.01 wt. %, of further plasticizers, preferably of mineral oils, in particular of naphthenic oils, and is most preferably free of these further plasticizers, based on the total weight of the composition.

In a preferred embodiment, the at least one further plasticizer (or the required amount of plasticizer) is replaced in the pressure-sensitive adhesive composition by the at least one polyester polyol based on betulin to a degree of at least 50%, more preferably at least 60%, even more preferably at least 70%, even more preferably at least 80%, even more preferably at least 90%, even more preferably at least 95%, even more preferably at least 98%, even more preferably at least 99%, and most preferably 100%.

In a further preferred embodiment, the pressure-sensitive adhesive composition has a proportion of renewable raw materials of 50 to 100 wt. %, preferably at least 60 wt. %, more preferably at least 70 wt. %, even more preferably at least 80 wt. %, even more preferably at least 90 wt. %, even more preferably at least 95 wt. %, most preferably at least 99 wt. %, in each case based on the total weight of the pressure-sensitive adhesive composition.

In addition to the at least one polyester polyol based on betulin, the pressure-sensitive adhesive composition according to the invention can also contain at least one resin.

Resins are typically used to change, preferably lower, the viscosity of the pressure-sensitive adhesive composition according to the invention and to influence the smell, the (initial) color and the color stability of the composition, and the tackiness and polarity of any polymers present.

These are, in particular, resins which have a softening point of 35 to 160° C. or up to 130° C. (ring-and-ball method, DIN 52011). Suitable resins include, but are not limited to, aromatic, aliphatic or cycloaliphatic hydrocarbon resins, and modified or hydrogenated versions thereof. Specific examples are: aliphatic or alicyclic petroleum hydrocarbon resins and hydrogenated derivatives thereof. Other resins which can be used within the scope of the invention are, for example, hydroabietyl alcohol and the esters thereof, in particular esters having aromatic carboxylic acids such as terephthalic acid and phthalic acid; modified natural resins such as resin acids from balsamic resin, tall resin or root resin, for example fully saponified balsamic resin; alkyl esters of optionally partially hydrogenated colophony having low softening points, such as methyl, diethylene glycol, glycerol and pentaerythritol esters; terpene resins, in particular terpolymers or copolymers of terpene, such as styrene terpenes, a-methyl styrene terpenes, phenol-modified terpene resins and hydrogenated derivatives thereof; acrylic acid copolymers, preferably styrene-acrylic acid copolymers and resins based on functional hydrocarbon resins.

The at least one resin is preferably a natural resin or a hydrogenated and/or non-hydrogenated hydrocarbon resin, more preferably a tall oil ester, gum rosin (colophony), an optionally partially polymerized tall resin, a terpene or a crude-oil-based aliphatic, aromatic or cycloaliphatic hydrocarbon resin, and modified or hydrogenated versions thereof, for example C5 aliphatic or C9 aromatic hydrocarbon resin or a C5/C9 monomer mixture.

In a particular embodiment, the at least one resin is contained in the pressure-sensitive adhesive composition in an amount of 15 to 70 wt. %, for example 50 to 70 wt. %, preferably 20 to 60 wt. %, for example 40 to 60 wt. % or 50 to 60 wt. %, based on the total weight of the composition.

According to the invention, both solid and liquid resins can be used.

The pressure-sensitive adhesive composition according to the invention can also contain at least one additive. Suitable additives include, but are not limited to, components from the group consisting of antioxidants, in particular stabilizers, waxes, UV protectors, solvents, adhesion promoters, fillers, pigments, flame retardants, UV absorbers, optical brighteners and fragrances.

The at least one additive is preferably contained in the composition in an amount of 0.01 to 20 wt. %, more preferably 0.1 to 5 wt. %, even more preferably 0.5 to 3 wt. %, based on the total weight of the composition.

Antioxidants such as stabilizers are particularly preferably used in the pressure-sensitive adhesive composition according to the invention, preferably in an amount of 0.01 to 10 wt. %, more preferably 0.1 to 5 wt. %, even more preferably 0.5 to 2 wt. %. They are used, for example, against thermal and oxidative degradation caused by oxygen and UV radiation. In addition, antioxidants can improve heat stability and/or color stability.

When using stabilizers, it must be ensured that they are compatible with the pressure-sensitive adhesive composition. For example, antioxidants that are available under the trade name Irganox® (BASF SE) can be used as stabilizers, preferably in amounts of 0.5 to 1.5 wt. %, for example 1 wt. %, based on the total weight of the composition.

In various embodiments, waxes can optionally be added to the pressure-sensitive adhesive composition in amounts of 0.5 to 5 wt. %. In this case, the amount is measured such that the viscosity is reduced to the desired range while not negatively influencing the adhesion. The wax can be of natural origin, optionally also in chemically modified form, or of synthetic origin. Plant waxes, animal waxes, mineral waxes or petrochemical waxes can be used as natural waxes. Hard waxes such as montan ester waxes, sasol waxes, etc., can be used as chemically modified waxes. Polyalkylene waxes and polyethylene glycol waxes are used as synthetic waxes. Petrochemical waxes such as petrolatum, paraffin waxes, microcrystalline waxes and synthetic waxes are preferably used. Paraffinic and/or microcrystalline waxes and/or hydrogenated versions thereof are particularly preferred, in particular polypropylene or polyethylene wax having a dropping point, determined according to ASTM D-3954, of from 50° C. to 170° C.

The consistency of the pressure-sensitive adhesive composition according to the invention can be adjusted according to the particular requirements, for example by adding suitable solvents. In various embodiments, the pressure-sensitive adhesive composition according to the invention also comprises one or more solvents.

Taking into account the considerable environmental and economic demands associated with the use of in particular organic solvents, it is advantageous, however, to dispense with the use of solvents. An embodiment is therefore preferred in which the pressure-sensitive adhesive composition according to the invention is free of solvents. The use of solvents can be entirely or partly dispensed with when the properties of the polyester polyol used are selected appropriately. In this context, an embodiment of the pressure-sensitive adhesive composition according to the invention is therefore preferred in which the used polyester polyol based on betulin has an OH number of 5 to 200 mg KOH/g, preferably 20 to 140 mg KOH/g. The hydroxyl number (OH number) is considered according to the invention to be a measure of the number of free hydroxyl groups in a particular defined reference amount. In this case, the OH number can be determined experimentally by means of potentiometric titration or by means of acid-base titration.

In a preferred embodiment, the pressure-sensitive adhesive composition according to the invention is solvent-containing, solvent-free or a dispersion.

In a particularly preferred embodiment, the pressure-sensitive adhesive composition comprises or consists of

a) at least one polymer, preferably an SIS polymer;
b) at least one polyester polyol based on betulin;
c) at least one resin, preferably a tall oil resin such as pentaerythritol resin ester or an aliphatic hydrocarbon resin; and
d) at least one additive, preferably a stabilizer;
wherein the components are preferably used as described below in the pressure-sensitive adhesive composition:
a) 10 to 70 wt. %, preferably 15 to 70 wt. %, more preferably 20 to 70 wt. %, for example 20 to 50 wt. %, 30 to 60 wt. % or 25 to 40 wt. %; and/or
b) 1 to 50 wt. %, preferably 2 to 40 wt. %, more preferably 5 to 40 wt. %, even more preferably 5 to 30 wt. %, for example 15 to 30 wt. % or 20 to 30 wt. %; and/or
c) 15 to 70 wt. %, preferably 20 to 60 wt. %, for example 40 to 60 wt. % or 50 to 60 wt. %;

and/or

d) 0.01 to 20 wt. %, preferably 0.1 to 5 wt. %, more preferably 0.5 to 3 wt. %;

based on the total weight of the pressure-sensitive adhesive composition.

In another embodiment, the pressure-sensitive adhesive composition comprises or consists of

a) at least one polymer, preferably an SIS polymer;
b) at least one polyester polyol based on betulin;
c) at least one resin, preferably a tall oil resin such as pentaerythritol resin ester or an aliphatic hydrocarbon resin;
d) at least one additive, preferably at least one stabilizer;
e) optionally at least one wax; and
f) optionally at least one further plasticizer;
wherein the components are preferably used as described below in the pressure-sensitive adhesive composition:
a) 10 to 70 wt. %, preferably 15 to 70 wt. %, more preferably 20 to 70 wt. %, for example 20 to 50 wt. %, 30 to 60 wt. % or 25 to 40 wt. %; and/or
b) 1 to 50 wt. %, preferably 2 to 40 wt. %, more preferably 5 to 40 wt. %, even more preferably 5 to 30 wt. %, for example 15 to 30 wt. % or 20 to 30 wt. %; and/or
c) 15 to 70 wt. %, preferably 20 to 60 wt. %, for example 40 to 60 wt. % or 50 to 60 wt. %;
and/or
d) 0.01 to 20 wt. %, preferably 0.1 to 10 wt. %, more preferably 0.1 to 5 wt. %, even more preferably 0.5 to 5 wt. %, in particular 0.5 to 3 wt. %; and/or
e) a maximum of 10 wt. %, preferably a maximum of 8 wt. %, more preferably a maximum of 5 wt. %;
f) a maximum of 15 wt. %, preferably a maximum of 5 wt. %, more preferably a maximum of 1 wt. %, even more preferably a maximum of 0.1 wt. %, even more preferably a maximum of 0.01 wt. %, the composition most preferably being free of further plasticizers;
based on the total weight of the pressure-sensitive adhesive composition.

High demands are placed in particular on food packaging and on the substances used to produce said packaging. In addition to the mechanical properties, the focus is in particular on health aspects. Within the scope of the present invention, it has surprisingly been found that, by using a polyester polyol based on betulin, the formation of what are referred to as critical migratable cycles can be prevented. Critical migratable cycles are understood to mean compounds which are capable of migrating from the adhesive into the packaging material or the packaged product, for example an item of food, and which thus have the potential to be harmful to health. An embodiment of the pressure-sensitive adhesive composition according to the invention is therefore preferred in which the proportion of critical migratable constituents in the pressure-sensitive adhesive composition is less than 300 ppm, preferably less than 200 ppm, and particularly preferably less than 50 ppm, the ppm indicating proportions by weight and the amounts relating to the total weight of the pressure-sensitive adhesive composition.

In preferred embodiments of the pressure-sensitive adhesive composition according to the invention, the polyester polyol based on betulin partially or completely replaces migratable naphthenic oils or other mineral oils. Due to their polymeric character, there is preferably no migration or greatly reduced migration from the adhesive into materials, such as into packaging materials or into the packaged product, with the polyester polyols based on betulin compared to migratable naphthenic oils. This applies in particular to materials based on polyethylene, as there is no migration due to the ester structure of the polyester polyol.

Furthermore, replacing naphthenic oils with polyester polyols based on betulin increases the proportion of renewable raw materials in the formulation.

The pressure-sensitive adhesive composition according to the invention preferably has a lower viscosity compared to other adhesive compositions, as a result of which it can be applied at lower temperatures. This leads to energy and cost savings for the customer.

In a preferred embodiment, the pressure-sensitive adhesive according to the invention has a Brookfield viscosity (e.g., measurable at 20 RPM with spindle 27) at 140° C. of 5,000 to 160,000 mPas, in particular 8,000 to 30,000 mPas.

The softening point of the pressure-sensitive adhesive composition according to the invention is preferably higher, more preferably at least 5° C. higher, in particular at least 10° C. higher, than the softening point of reference adhesive compositions, which can bring about increased heat resistance.

In a preferred embodiment, the softening point of the pressure-sensitive adhesive according to the invention is above 100° C., in particular above 105° C. (ring-and-ball method, ASTM D36, glycerol).

In preferred embodiments, the pressure-sensitive adhesive composition according to the invention also has improved temperature stability in applications.

The pressure-sensitive adhesive composition according to the invention preferably has a glass transition temperature of −50 to 80° C., more preferably −10 to 30° C. (measurement: DMA).

The present invention further relates to a method for preparing the pressure-sensitive adhesive composition according to the invention, comprising the steps of:

a1) providing a reaction mixture comprising betulin, at least one plant oil and optionally at least one dicarboxylic acid, from which the polyester polyol based on betulin is formed or has already formed partially or completely; or
a2) providing a polyester polyol based on betulin; and
b) mixing the reaction mixture from step a1) or the polyester polyol based on betulin from step a2) with other components of the pressure-sensitive adhesive composition, such as the polymer and optionally other components such as at least one further plasticizer, at least one resin and/or at least one additive, in a suitable sequence;
preferably at a temperature of 100 to 200° C., more preferably at 120 to 180° C.

In a preferred embodiment, the other components of the pressure-sensitive adhesive composition, such as the polymer, resin and additive, are first provided and mixed before the reaction mixture from step a1) or the polyester polyol from step a2) is added.

The present invention also relates to the use of the pressure-sensitive adhesive composition according to the invention in tapes, labels, hygiene articles such as diapers, labeling, e.g., of beverage bottles, flexible packaging, films, food packaging, in the field of assembly (high performance, such as in the automotive industry), medical applications, and/or in the graphics industry (e.g., books, magazines, brochures).

The pressure-sensitive adhesives according to the invention are used for bonding substrates such as glass, metal, for example steel, woven fabrics, nonwovens, coated or uncoated paper, cardboard and plastics materials such as PET, PEN, PE, PP, PVC and PS. Thin flexible substrates, for example made of films, multi-layer films or paper, are then glued to solid substrates of this type. Said thin flexible substrates are, for example, labels, outer packaging, bags, etc., and can be made, for example, from plastics materials, for example from polyethylene, polypropylene, polystyrene, polyvinyl chloride or cellophane, in particular from PE films. However, the labels can also be based on paper, optionally in combination with polymer films. The hot-melt pressure-sensitive adhesives according to the invention are distinguished in particular by very good adhesion to the aforementioned plastics materials, although they can also be removed from the substrate surfaces again.

Further fields of application are described, for example, in the international patent publication WO 2016/062797 A1, in particular on pages 10-11.

In a preferred embodiment, the amount of pressure-sensitive adhesive composition applied is 1 to 200 g/m2, preferably 2 to 70 g/m2, more preferably 10 to 60 g/m2.

In a preferred embodiment, the substrates can optionally be subjected to a pretreatment and/or the two substrates are joined together under pressure.

The present invention further relates to an article comprising the pressure-sensitive adhesive composition according to the invention. In a preferred embodiment, the article can be obtained using the method according to the invention. The article is preferably a multi-layered substrate, in particular for packaging for food and pharmaceutical products, for hygiene articles, in the field of “labels” and “labeling,” but also for use in the automotive industry or the graphics industry.

All aspects, objects and embodiments described for the pressure-sensitive adhesive composition according to the invention can also be applied to the methods according to the invention, the article according to the invention, and the use according to the invention. Therefore, reference is expressly made at this juncture to the disclosure at the corresponding point when it was indicated that this disclosure also applies to the use according to the invention, the article according to the invention and the methods according to the invention.

The invention is described in the following with reference to examples, but is not limited to these examples.

### EXAMPLES

### Example 1

Preparation of the polyester polyols as a polymer mineral-oil-free raw material for pressure-sensitive adhesives was carried out according to the following procedure:

Castor oil or another plant oil was placed in a 1 liter four-necked flask equipped with a nitrogen inlet, thermostat, blade stirrer and distillation arm, and the appropriate amounts of antioxidant (1 wt. % Chinox 1010) and betulin were stirred in one after the other at room temperature. The reaction mixture was gradually heated and stirred in the nitrogen stream for about 1 hour at a temperature of 220° C. The reaction mixture was then cooled and optionally 0.02 wt. % of catalyst (85% phosphoric acid), based on the reaction mixture, was added.

The reaction mixture was then heated to 220° C. and stirred under nitrogen for a further 30 minutes. The temperature was then reduced to 200° C. and the appropriate amount of dicarboxylic acid (e.g., succinic acid) was optionally added in the nitrogen counterflow. The temperature was then increased again to 220° C. and stirred for a further 6 hours. The pressure in the reaction flask was then gradually reduced to 30 mbar. The acid number was continuously checked. As soon as the acid number fell below a value of 3 mg KOH/g with respect to the reaction mixture, the reaction mixture was first cooled such that a sample could be taken for analytical measurements based on the corresponding viscosity of the reaction mixture. Afterwards, the acid number and hydroxyl number were finally determined at 20° C. and the mixture was chromatographically characterized. If no dicarboxylic acid is added, the reaction can be monitored by the viscosity and a visual assessment (e.g., homogenization of the mixture into one phase).

For the purpose of chromatographic characterization by gel permeation chromatography (GPC), a sample of the reaction mixture was dissolved with tetrahydrofuran and applied to the column, and subsequently also eluted with tetrahydrofuran. Gel permeation chromatography (GPC) using an RI detector, after calibration by means of polystyrene standards, was carried out at a column oven temperature of 40° C. and a temperature in the detector of likewise 40° C. The relative number-average and weight-average molar masses were determined from the molar mass distribution curve, and the polydispersity was determined therefrom.

The polyester polyols were measured using differential calorimetry, wherein a sample of the reaction mixture was first heated to 150° C. in order to then be brought to −90° C. at a cooling rate of 10 Kelvin per minute. After 10 minutes at −90° C., the sample of the reaction mixture was heated to 150° C. at a heating rate of 10 Kelvin per minute and the DSC diagram was recorded. Glass transition temperatures of the liquid polyester polyols were determined using the DSC diagram.

The table shows the weights and the specific monomers for the preparation of a polyester polyol and its characteristics.

TABLE 1
Weights and specific monomers for the preparation of a polyester polyol

| | | | | Acid | OH | | |
|---|---|---|---|---|---|---|---|
| | | | | number | number | | |
| | | | Glass | in mg | in mg | | |
| | Monomer | Brookfield | transition | KOH/g | KOH/g | Mₙ in | |
| Example | composition | viscosity | temperature | sample | sample | g/mol | Polydispersity |
| Composition | 75.78 g betulin | 100 mPas | −51° C. | 1.8 | 70 | 2,984 | 2.5 |
| 1 | (17.8 mol. %) | at 140° C. | | | | | |
| | 379.40 g castor | | | | | | |
| | oil (42.7 mol. %) | | | | | | |
| | 44.85 g succinic | | | | | | |
| | acid (39.5 mol. %) | | | | | | |
| Composition | 83.15 g betulin | 6,000- | melting | | | 907 | 1.1 |
| 2 | (27.4 mol. %), | 10,000 mPas | point | | | | |
| | 416.85 g | at 23° C. | −22° C. | | | | |
| | rapeseed oil | | | | | | |
| | (65.4 mol. %), | | | | | | |
| | 10.1 g sebacic | | | | | | |
| | acid (7.2 mol. %) | | | | | | |

The preparation can be carried out analogously with every plant oil (soybean oil, linseed oil, sunflower oil, safflower oil, rapeseed oil, physic nut oil, light walnut oil, grapeseed oil, canola oil, corn oil, cashew kernel oil, fish oil, castor oil, tall oil, coconut oil, palm oil, palm kernel oil, olive oil, poppyseed oil, hempseed oil, avocado oil, algae oils and mixtures thereof). The addition of dicarboxylic acids (such as succinic acid or sebacic acid) is not mandatory, but can be used to adjust viscosity and other properties.

### Example 2

Preparation of a pressure-sensitive adhesive with polyester polyols from example 1:

The raw materials listed were formulated according to the mixing sequence listed in the table below at the specified temperature. The adhesive was mixed with a propeller mixer at speeds of 50-250 rpm.

TABLE 2
Formulation 1

| Raw material | | wt. | Weight | Mixing |
|---|---|---|---|---|
| type | Trade name | % | in g | temperature |
| SBC polymer | Europrene | 30 | 60 | 160° C. |
| | Sol T 190 | | | |
| Resin 1 | Sylvalite RE | 26.5 | 53 | |
| | 100s | | | |
| Resin 2 | Escorez 1310 | 27.5 | 55 | |
| Polyester | | 15.0 | 30 | |
| according to | | | | |
| example 1 | | | | |
| (composition 1) | | | | |
| Stabilizer | Irganox B225 | 1.0 | 2 | |

The adhesive according to the invention has a lower viscosity at 140° C. This allows it to be applied at lower temperatures compared to reference adhesive 1. This leads to energy and cost savings for the customer.

Despite the lower viscosity at 140 ° C., the pressure-sensitive adhesive has a softening point that is 12-14 ° C. higher and results in higher heat resistance compared to the reference adhesives.

TABLE 3
Physical properties

| | Mineral-oil-free | Reference 1 | Reference 2 |
|---|---|---|---|
| | pressure-sensitive | Technomelt | Technomelt |
| Method | adhesive | 8746 | PS 1212 |
| Brookfield viscosity | 140° C.: 12,300 | 140° C.: 26,500 | 140° C.: — |
| (20 RPM with spindle | 160° C.: 9,200 | 160° C.: 11,425 | 160° C.: 9,700 |
| 27) in mPas | | | |
| Softening point in ° C. | 110.2 | 98.0 | 96.4 |
| (ring-and-ball, ASTM | | | |
| D36, glycerol) | | | |
| Tg (DMA) in ° C. | 6.9 | 7.9 | −2.2 |
| Crossover (DMA) in | 89.5 | 86.1 | 74.6 |
| ° C. | | | |

The coatings required to carry out the adhesion tests are produced on a laboratory scale on a heatable coating table. This table has a heated and movable doctor blade that can be used to draw the adhesive across the table. The layer thickness is set using two adjusting screws for rough adjustment and two adjusting screws for fine adjustment. The gap width between the doctor blade and the heating plate is displayed by means of two manometers, which rest on the doctor blade above the adjusting screws. Here, the gap width in micrometers can be read off a scale. The adhesive is applied to silicone paper, which is fixed to the plate by a vacuum. After the adhesive layer has been applied, it is rolled onto a PET film. After checking the application weight with a maximum deviation of ±10% and a rest period of 24 hours, the finished coating can be used for the test. The coatings were made with a 50 μm thick PET film and an application weight of 40 g/m².

The following table provides 180° peel and loop tack adhesion values on various substrates. The mineral-free adhesive according to the invention has comparable values to a good label and all-rounder pressure-sensitive adhesive (reference 1) and significantly better values compared to a standard label pressure-sensitive adhesive (reference 2).

TABLE 4
Adhesive properties

| | | Adhesive values of | | |
|---|---|---|---|---|
| | | mineral-oil-free | Reference 1 | Reference 2 |
| | | pressure-sensitive | Technomelt | Technomelt |
| Method | Substrate | adhesive | 8746 | PS 1212 |
| Peel 180° | Steel (after 20 min) | 34N | 39N | 18N |
| (FINAT-FTM1) | Steel (after 24 hr) | 33N | 36N | 17N |
| based on 25 | LD polyethylene | 20N | 19N | |
| mm wide PET | (after 20 min) | | | |
| coating | LD polyethylene | 19N | 17N | |
| | (after 24 hr) | | | |
| | Nonwoven (after | 13N | 12N | |
| | 20 min) | | | |
| | Cardboard | 18N | 17N | |
| Loop tack | Steel | 44N | 47N | |
| based on | Glass | 43N | 34N | 27N |
| 25 mm × | LD polyethylene | 15N | 24N | |
| 25 mm PET | | | | |
| coating | | | | |

### Example 3:

TABLE 5
Formulation 2

| Raw material | | wt. | Weight | Mixing |
|---|---|---|---|---|
| type | Trade name | % | in g | temperature |
| SIS polymer | Vector 4114 N | 20 | 40 | 160° C.-180° C. |
| Resin 1 | Escorez 2203LC | 17.5 | 35 | |
| Resin 2 | Regalite S 1100 | 39.5 | 79 | |
| Polyester | | 20 | 40 | |
| according to | | | | |
| example 1 | | | | |
| (composition 2) | | | | |
| Stabilizer | Irganox 1010 | 1 | 2 | |

The adhesive according to the invention contains polyester composition 2 from example 1 as a mineral-oil-free plasticizer. The plasticizer component according to the invention can be incorporated very easily in comparison to the mineral oil plasticizer in a reference adhesive. The adhesive properties are compared below. Resin 1 is a conventional non-hydrogenated hydrocarbon resin and resin 2 is a hydrogenated hydrocarbon resin.

### Adhesive Test on Greaseproof Paper

The aim is to assess the connection between two substrates made of greaseproof paper. The connection is closed by bead application of a hot-melt pressure-sensitive adhesive (HMPSA).

### Method

The adhesive must be heated to the application temperature. Using a thermometer, a thin bead is applied to a rectangular sheet of greaseproof paper. This bead is immediately covered with a strip of greaseproof paper and pressed down by hand. Industrial heat bonding is intended to be simulated. The bond is temperature-controlled at room temperature (RT) for 24 hours. The samples are then separated by hand. The force applied must be assessed qualitatively, as well as the flexibility and the fracture pattern. Possible results can be found in the assessment matrix below.

TABLE 6
Assessment matrix

| Criteria | | | |
|---|---|---|---|
| Force | 0 | + | ++ |
| Flexible behavior | elastic | not elastic | |
| Fracture pattern | adhesive | cohesive | substrate |
| | fracture | fracture | fracture |

Elastic: Property of the adhesive to deform under the action of force. The adhesive follows the applied force by stretching without the connection being released.
Not elastic: Property of the adhesive to become brittle under the action of force. The connection is abruptly released and the adhesive peels off one substrate.
Adhesive fracture: Bond failure in the interface between the substrate and the adhesive. The adhesive remains fully on one of the two substrates after separation.
Cohesive fracture: Bond failure in the adhesive layer. The adhesive remains on both of the two substrates after separation.

### Adhesive Test to Check the Melting Behavior

This test is used to check the melting behavior. The adhesive is measured against a reference.

### Method

A cube with an edge length of 3 cm is cast from the HMPSA using a silicone mold. A drying cabinet is temperature-controlled to 160° C. The adhesive to be compared is melted together with the reference adhesive cube in the drying cabinet. During this time, the melting behavior is assessed visually every second minute.

TABLE 7
Assessment matrix for melting behavior

| | |
|---|---|
| Not melted | − |
| Almost melted | 0 |
| Melted | + |

TABLE 8
Results

| | | Qualitative | | | |
|---|---|---|---|---|---|
| | | adhesion test | | | |
| | | BROWN (Weber) | | | |
| | | paper/paper | Melting (at 160° C.), cube 3 × 3 × 3 cm | | |
| | | adhesive, RT, 24 h | 2-8 min | 10-16 min | 18-24 min |
| Mineral-oil-free | Adhesive | + | − | + | + |
| pressure-sensitive | strength | | | | |
| adhesive 2 | Flexibility | elastic | − | + | + |
| according to the | assessment | | | | |
| invention | Fracture | adhesive fracture | 0 | + | + |
| | pattern | | | | |
| | Contains | no | 0 | + | + |
| | mineral oils | | | | |
| Reference | Adhesive | + | − | 0 | + |
| containing mineral | strength | | | | |
| oils | Flexibility | elastic | − | 0 | + |
| | assessment | | | | |
| | Fracture | adhesive fracture | − | + | + |
| | pattern | | | | |
| | Contains | yes | − | + | + |
| | mineral oils | | | | |

The adhesive according to the invention contains 20% of the polyester with composition 2 as a mineral-oil-free plasticizer. The reference adhesive has comparable adhesive properties but contains a plasticizer that contains mineral oils. Another advantage of the adhesive according to the invention is its improved melting behavior compared to the reference.

1. A pressure-sensitive adhesive composition comprising
a. at least one polymer;
b. at least one polyester polyol based on betulin;
c. optionally at least one plasticizer;
d. optionally at least one resin; and
e. optionally at least one additive.

2. The pressure-sensitive adhesive composition according to claim 1, wherein the at least one polymer is selected from the group of polymers based on acrylate, polyester, urethane, ethylene acrylate, butyl rubber and (synthetic) natural rubber; ethylene-vinyl acetate copolymers (EVA), polyolefin (co)polymers (PO), polyamide (co)polymers (PA), ethylene-propylene copolymers or styrene copolymers, individually or a mixture thereof, wherein the polymer is contained in the composition in an amount of 10 to 70 wt. %, based on the total weight of the composition.

3. The pressure-sensitive adhesive composition according to claim 1, wherein the polyester polyol is obtained from a reaction mixture comprising the following monomer units:
i) betulin, in an amount of 5 to 40 wt. %;
at least one triglyceride, in an amount of 30 to 95 wt. %, and
iii) optionally at least one dicarboxylic acid, in an amount of 1 to 40 wt. %
wherein the weight specifications are based on the total weight of the monomer units.

4. The pressure-sensitive adhesive composition according to claim 3, wherein the triglyceride is selected from the group consisting of soybean oil, linseed oil, sunflower oil, safflower oil, rapeseed oil, physic nut oil, light walnut oil, grapeseed oil, canola oil, corn oil, cashew kernel oil, fish oil, castor oil, tall oil, coconut oil, palm oil, palm kernel oil, olive oil, poppyseed oil, hempseed oil, avocado oil, algae oils, and mixtures or derivatives thereof.

5. The pressure-sensitive adhesive composition according to claim 3, wherein the dicarboxylic acid is selected from the group consisting of succinic acid, adipic acid, azelaic acid, sebacic acid, dodecanoic acid, tetradecanedioic acid, furandicarboxylic acid, isophthalic acid, terephthalic acid, orthophthalic acid, glutaric acid, oxalic acid, malonic acid, itaconic acid, and mixtures thereof.

6. The pressure-sensitive adhesive composition according to claim 1, wherein the polyester polyol is contained in the composition in an amount of 5 to 40 wt. %, based on the total weight of the composition.

7. The pressure-sensitive adhesive composition according to claim 1, wherein the composition is free of any mineral oils.

8. The pressure-sensitive adhesive composition according to claim 1, wherein the at least one resin is a C5 aliphatic or C9 aromatic hydrocarbon resin and is present in an amount of 15 to 70 wt. %, based on the total weight of the composition.

9. The pressure-sensitive adhesive composition according to claim 1, wherein the at least one additive is selected from the group consisting of antioxidants, stabilizers, waxes, UV protectors, solvents, adhesion promoters, fillers, pigments, flame retardants, UV absorbers, optical brighteners and fragrances, the at least one additive being contained in the composition in an amount of 0.01 to 20 wt. %, based on the total weight of the composition.

10. A method for preparing a pressure-sensitive adhesive composition comprising the steps of:
a) providing a polyester polyol prepared from betulin; and mixing the polyester polyol with at least one polymer and optionally, at least one plasticizer, a resin and/or an additive at a temperature of 100 to 200° C.

11. The method of claim 10, wherein the polyester polyol is prepared from a reaction mixture of betulin, a triglyceride, and optionally a dicarboxylic acid, wherein the polyester polyol is partially formed.

12. An article comprising the pressure-sensitive adhesive composition according to claim 1 and a substrate.

13. A method for bonding at least two substrates, having a first substrate and a second substrate comprising:
a. Applying the pressure sensitive composition according to claim 1 onto the first substrate; and
b. Joining the second substrate onto the pressure sensitive composition,
whereby the pressure sensitive composition is sandwiched between the first and the second substrates.

14. The article of claim 12, which is a tape, label, diaper, flexible packaging, food packaging, automotive parts, or graphics.
